(19) United States
(12) Patent Application Publication
(10) Pub. No.: US 2009/0087669 A1
(43) Pub. Date: Apr. 2, 2009

(54) Glass laminates comprising acoustic interlayers and solar control films

(76) Inventors: Richard A. Hayes, Beaumont, TX (US); Donald L. Rymer, Little Hocking, OH (US); Jerrel C. Anderson, Vienna, WV (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/904,872

(22) Filed: Sep. 28, 2007

(51) Int. Cl. B32B 17/06

(52) U.S. Cl. 428/430; 428/432

(57) ABSTRACT

Provided is a glass/plastic safety laminate comprising a monolayer acoustic poly(vinyl acetal) interlayer sheet and optionally other suitable interlayer sheet(s) bonded between a glass sheet and a hardcoated solar control polymeric film.

### FIELD OF THE INVENTION

The present invention relates to safety laminates with improved sound damping and solar control properties.

### BACKGROUND OF THE INVENTION

Glass laminated products have contributed to society for almost a century. Beyond the well known, every day automotive safety glass used in windshields, laminated glass is used in windows for trains, airplanes, ships, and nearly every other mode of transportation. Safety glass is characterized by high impact and penetration resistance, and it does not scatter glass shards and debris when shattered.

Safety glass typically consists of a sandwich of two glass sheets or panels bonded together with an interlayer of a polymeric film or sheet. One or both of the glass sheets may be replaced with optically clear rigid polymeric sheets, such as sheets of polycarbonate materials. Safety glass has further evolved to include multiple layers of glass or rigid polymeric sheets bonded together with interlayers that may include one or more polymeric films or sheets.

The interlayer is typically made with a relatively thick polymeric film or sheet, which exhibits toughness and bondability to provide adhesion to the glass in the event of a crack or crash. Over the years, a wide variety of polymeric interlayers have been developed for use in safety glass. In general, these polymeric interlayers must possess a combination of characteristics including very high optical clarity, low haze, high impact resistance, high penetration resistance, excellent ultraviolet light resistance, good long term thermal stability, excellent adhesion to glass and other rigid polymeric sheets, low moisture absorption, high moisture resistance, and excellent long term weatherability. Widely used interlayer materials include complex, multicomponent compositions based on poly(vinyl butyral) (PVB), polyurethane (PU), poly(vinyl chloride) (PVC), linear low density polyethylenes (e.g., metallocene catalyzed low density polyethylenes), poly(ethylene-co-vinyl acetate) (EVA), polymeric fatty acid polyamides, polyesters (e.g., poly(ethylene terephthalate) (PET)), silicone elastomers, epoxy resins, elastomeric polycarbonates, and the like.

A more recent trend has been the use of glass laminated products in the construction business for homes and office structures. The use of architectural safety glass has expanded rapidly over the years as designers have incorporated more glass surfaces into buildings. In conjunction with this development, threat resistance has become an ever increasing requirement for architectural glass laminated products. Thus, newer safety glass products are designed to resist both natural and man made disasters. Examples of these needs include the recent developments of hurricane resistant glass, now mandated in hurricane susceptible areas, theft resistant glazings, and the more recent blast resistant glass laminated products. These products have great enough strength to resist intrusion even after the glass in the laminate has been broken, for example, the interlayer maintains its integrity against further insult when a glass laminate is subjected to high force winds and impacts of flying debris as occur in a hurricane or where there are repeated impacts on a window by a criminal attempting to break into a vehicle or structure.

In addition, glass laminated products have now reached the strength requirements for being incorporated as structural elements within buildings. For example, many buildings now feature staircases fabricated from laminated glass.

Society continues to demand more functionality from laminated glass products beyond the strength and safety characteristics described above. One area of need is to reduce the energy consumption within the structure, such as an automobile or building, of which the laminated glass is a part. This need has been met through the development of solar control laminated glass structures. The solar energy strikes the earth over a wide spectral range of from 350 nm to 2,100 nm, with the maximum intensity found at 500 nm. The solar energy is divided into spectral regions, such as the ultraviolet region of 449 nm or less, the visible region of 450 nm to 749 nm and the near infrared region of 750 nm to 2,100 nm. The solar energy intensity distribution across these spectral regions is 4.44% for the ultraviolet region, 46.3% for the visible region and 49.22% for the near infrared region. Removing the energy from the visible region would sacrifice visual transparency through windows and, therefore, detract from the purpose for having windows. Since the near infrared region is not sensed by the human eye, however, typical solar control glass laminates have attempted to remove the energy from the near infrared region. For example, the air conditioning load in the summer may be reduced in buildings, automobiles and the like, which are equipped with solar control windows that prevent the transmission of near infrared radiation.

These solar control glass laminates may be obtained through modification of the glass or of the polymeric interlayer, through the addition of further solar control layers, or through combinations of these techniques.

A recent trend has been the use of metal oxide nanoparticles. These materials absorb the infrared light and convert the energy to heat. To preserve the clarity and transparency of the substrate, these materials need to have nominal particle sizes below about 50 nm.

Infrared-absorbing nanoparticles which have attained commercial significance are antimony tin oxide (ATO) and indium tin oxide (ITO). These nanoparticles are typically produced through either a precipitation/calcination procedure or a flame pyrolysis process. Antimony tin oxide particles and indium tin oxide particles may be produced as disclosed within, e.g., U.S. Pat. No. 4,478,812; U.S. Pat. No. 4,937,148; U.S. Pat. No. 5,075,090; U.S. Pat. No. 5,376,308; U.S. Pat. No. 5,772,924; U.S. Pat. No. 5,807,511; U.S. Pat. No. 5,518,810; U.S. Pat. No. 5,622,750; U.S. Pat. No. 5,958,631; U.S. Pat. No. 6,051,166; and U.S. Pat. No. 6,533,966. These antimony tin oxide nanoparticles and indium tin oxide nanoparticles have been incorporated into polymeric interlayers of glass laminates or used to form solar control coatings on film substrates.

A more recent trend has been the use of metal boride nanoparticles, such as lanthanum hexaboride (LaB₆). These materials also absorb the infrared light and convert the energy to heat. To preserve the clarity and transparency of the substrate, these materials need to have nominal particle sizes below about 200 nm.

A shortcoming of solar control laminates which incorporate infrared absorptive materials is that a significant proportion of the light absorbed serves to generate heat, some of which radiates into the very structure that the solar control laminate was meant to protect. This is especially true for stationary structures, such as parked automobiles and buildings.

One development to produce solar control laminated glass is the inclusion of metallized substrate films, such as polyester films, which have metal layers, such as aluminum or silver metal, applied thereon through a vacuum deposition or a sputtering process. These supported metal stacks are disclosed in, e.g., U.S. Pat. No. 3,718,535; U.S. Pat. No. 3,816,201; U.S. Pat. No. 3,962,488; U.S. Pat. No. 4,017,661; U.S. Pat. No. 4,166,876; U.S. Pat. No. 4,226,910; U.S. Pat. No. 4,234,654; U.S. Pat. No. 4,368,945; U.S. Pat. No. 4,386,130; U.S. Pat. No. 4,450,201; U.S. Pat. No. 4,465,736; U.S. Pat. No. 4,782,216; U.S. Pat. No. 4,786,783; U.S. Pat. No. 4,799,745; U.S. Pat. No. 4,973,511; U.S. Pat. No. 4,976,503; U.S. Pat. No. 5,024,895; U.S. Pat. No. 5,069,734; U.S. Pat. No. 5,071,206; U.S. Pat. No. 5,073,450; U.S. Pat. No. 5,091,258; U.S. Pat. No. 5,189,551; U.S. Pat. No. 5,264,286; U.S. Pat. No. 5,306,547; U.S. Pat. No. 5,932,329; U.S. Pat. No. 6,391,400; and U.S. Pat. No. 6,455,141. The metallized films are generally disclosed to reflect the appropriate light wavelengths to provide the desired solar control properties. For example, Fujimori, et. al., in U.S. Pat. No. 4,368,945, disclose an infrared reflecting laminated glass for automobile consisting of an infrared reflecting film with tungsten oxide layers between a silver layer sandwiched between poly(vinyl butyral) layers which incorporate ultraviolet absorbents. Brill, et. al., in U.S. Pat. No. 4,450,201, disclose a multilayer heat barrier film. Nishihara, et. al., in U.S. Pat. No. 4,465,736, disclose a laminate with a selective light transmitting film. Woodard, in U.S. Pat. No. 4,782,216 and U.S. Pat. No. 4,786,783, discloses a transparent, laminated window with near infrared rejection which included two transparent conductive metal layers. Farmer, et. al., in U.S. Pat. No. 4,973,511, disclose a laminated solar window construction which includes a PET sheet with a multilayer solar coating. Woodard, in U.S. Pat. No. 4,976,503, discloses an optical element for a motor vehicle windshield which includes light-reflecting metal layers. Hood, et. al., in U.S. Pat. No. 5,071,206, disclose reflecting interference films. Moran, in U.S. Pat. No. 5,091,258, discloses a laminate which incorporates an infra-red radiation reflecting interlayer. Frost, et. al., in U.S. Pat. No. 5,932,329, disclose a laminated glass pane comprising a transparent support film of a tear-resistant polymer provided with an infrared-reflecting coating and two adhesive layer. Woodard, et. al., in U.S. Pat. No. 6,204,480, disclose thin film conductive sheets for automobile windows. Russell, et. al., in U.S. Pat. No. 6,391,400, disclose dielectric layer interference effect thermal control glazings for windows. Woodard, et. al., in U.S. Pat. No. 6,455,141, disclose a laminated glass that incorporates an interlayer carrying an energy-reflective coating. Kramling, et. al., in EP 0 418 123 B1, disclose laminated glass with an interlayer comprising a copolymer of vinyl chloride and glycidyl methacrylate with a plasticizer content of 10 to 40 wt % or a thermoplastic polyurethane. The interlayer may be coated with a reflecting film and the reflecting film may have a surface resistivity of between 2 and 6 Ohms per square. Longmeadow, in U.S. Pat. No. 7,157,133, discloses embossed reflective laminates.

Laminated glass products are capable of providing even more useful properties beyond the safety, display, and solar control characteristics described above. One area of need is for the automotive windshield to function as an acoustic barrier to reduce the level of noise intrusion into the automobile. Acoustic laminated glass is generally known within the art. For example, Asahina, et. al., in U.S. Pat. No. 5,190,826, disclose a sound-insulating interlayer for glass laminates, the interlayer in the form of a laminated film comprising at least one resin film of a poly(vinyl acetal) having a degree of acetalization of at least 50% prepared from an aldehyde having 6 to 10 carbon atoms and a plasticizer and at least one resin film of a poly(vinyl acetal) having a degree of acetalization of at least 50% prepared from an aldehyde having 1 to 4 carbon atoms and a plasticizer or the interlayer in the form of a laminated film comprising a mixture of a poly(vinyl acetal) having a degree of acetalization of at least 50% prepared from an aldehyde having 6 to 10 carbon atoms, a poly(vinyl acetal) having a degree of acetalization of at least 50% prepared from an aldehyde having 1 to 4 carbon atoms and a plasticizer. Ueda, et. al., in U.S. Pat. No. 5,340,654, disclose a sound-insulating interlayer for glass laminates comprising laminated layers of at least one layer which comprises a plasticizer and a poly(vinyl acetal) resin which has 4 to 6 carbon atoms in the acetal group and the average amount of ethylene groups bonded to acetyl groups is 8 to 30 mole % and of at least one layer which comprises a plasticizer and a poly(vinyl acetal) resin which has 3 to 4 carbon atoms in the acetal group and the average amount of ethylene groups bonded to acetyl groups is 4 mole % or less. Rehfeld, et. al., in U.S. Pat. No. 5,368,917 and U.S. Pat. No. 5,478,615, disclose acoustic laminated glazings for vehicles comprising conventional poly(vinyl butyral). The sound damping properties of the poly(vinyl butyral) laminate described therein is highly temperature dependent. Melancon, et. al., in U.S. Pat. No. 5,464,659, disclose radiation curable silicone/acrylate vibration damping articles. Rehfeld, in U.S. Pat. No. 5,773,102, discloses multilayer acoustic laminates comprising a non-acoustic layer and an acoustic layer, wherein the acoustic layer may be composed of certain plasticized terpoly(vinyl chloride-co-glycidyl methacrylate-co-ethylene) materials. Hornsey, in U.S. Pat. No. 5,965,853, discloses a vibration dampening sound absorbing aircraft transparency. Garnier, et. al., in U.S. Pat. No. 6,074,732, disclose a soundproofing laminated window made of two glass sheets with a PVB/PET/acrylate/PET/PVB interlayer. Benson, Jr., et. al., in U.S. Pat. No. 6,119,807, disclose sound dampening glazing which includes a sheet of a sound dampening material. Landin, et. al., in U.S. Pat. No. 6,132,882, disclose acoustic glass laminates which incorporate certain acrylate acoustic layers. Friedman, et. al., in U.S. Pat. No. 6,432,522, disclose an acoustical barrier glazing which includes a multilayer interlayer. Yuan, et. al., in U.S. Pat. No. 6,825,255, disclose certain plasticized poly(vinyl butyral) sheets which include a fatty acid amide. Keller, et. al., in U.S. Pat. No. 6,887,577, disclose acoustic glass laminates which incorporate an acoustic layer of a plasticized poly(vinyl butyral) which includes 50 to 80 wt % of a poly(vinyl butyral) and 20 to 50 wt % of a softener mixture. Bennison, et. al., in US 2006/0008648, disclose a glass laminate interlayer having sound-damping properties comprising a poly(vinyl butyral) resin having a hydroxyl number in the range of from 17 to 23 and 40 to 50 parts per hundred (pph) of a single plasticizer.

Accordingly, described herein are durable and safe glass laminates with improved sound damping and solar control properties.

### SUMMARY OF THE INVENTION

The invention is directed to an acoustic solar control laminate comprising a polymeric interlayer sheet bonded between a rigid sheet and a polymeric film, wherein: (a) the rigid sheet is formed of a material having a modulus of at least about 100,000 psi (690 MPa); (b) the polymeric interlayer sheet is a monolayer sheet comprising an acoustic poly(vinyl acetal) composition having a glass transition temperature of 23° C. or less; (c) the polymeric film has an inbound surface that is adjacent to the polymeric interlayer and an outbound surface that is distal to the polymeric interlayer sheet; and (d) at least one of the two surfaces of the polymeric film is at least partially coated with an infrared energy reflective layer comprising a metal layer or a Fabry-Perot type interference filter layer.

The acoustic solar control laminate may further comprise one or more additional polymeric interlayers which are made of polymeric materials having a modulus of 20,000 psi (138 MPa) or less, or preferably, selected from poly(ethylene-co-vinyl acetates), poly(vinyl butyrals), and combinations thereof.

The invention is further directed to an acoustic solar control laminate consisting essentially of a polymeric interlayer sheet bonded between a glass sheet and a polyester film, wherein: (a) the polymeric interlayer sheet is a monolayer sheet comprising an acoustic poly(vinyl acetal) composition having a glass transition temperature of 23° C. or less; (b) the polyester film has its inbound surface, which is adjacent to the polymeric interlayer sheet, coated with an infrared energy reflective layer comprising a metal layer or a Fabry-Perot type interference filter layer; and (c) the polyester film has its outbound surface, which is further away from the polymeric interlayer sheet, coated with an abrasion-resistant hardcoat.

### DETAILED DESCRIPTION OF THE INVENTION

All publications, patent applications, patents, and other references mentioned herein are incorporated by reference in their entirety. Unless otherwise defined, all technical and scientific terms used herein have the same meaning as commonly understood by one of ordinary skill in the art to which this invention belongs. In case of conflict, the present specification, including definitions, will control.

Although methods and materials similar or equivalent to those described herein can be used in the practice or testing of the invention, suitable methods and materials are described herein.

The following definitions apply to the terms as used throughout this specification, unless otherwise limited in specific instances.

As used herein, the term “acoustic” refers to certain poly(vinyl acetal) compositions for convenience in describing the invention, although the actual materials may be called by other names in some instances, and any poly(vinyl acetal) composition having the general characteristics described herein for acoustic poly(vinyl acetal) compositions can be used in practicing the invention.

Layers and surfaces that are described herein as adjacent or proximal may in some embodiments also be adjoining, meaning that they are in direct contact over some portion of their interface, or contiguous, meaning that they are in direct contact over substantially the entire surface of their interface.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. “A ‘consisting essentially of’ claim occupies a middle ground between closed claims that are written in a ‘consisting of’ format and fully open claims that are drafted in a ‘comprising’ format.” Optional additives as defined herein, at levels that are appropriate for such additives, and minor impurities are not excluded from a composition by the term “consisting essentially of”, however.

Where applicants have defined an invention or a portion thereof with an open-ended term such as “comprising,” it should be readily understood that (unless otherwise stated) the description should be interpreted to also describe such an invention using the terms “consisting essentially of” or “consisting of.”

Use of “a” or “an” are employed to describe elements and components of the invention. This is done merely for convenience and to give a general sense of the invention. This description should be read to include one or at least one and the singular also includes the plural unless it is obvious that it is meant otherwise.

Polymers are sometimes referred to herein by the monomers used to make them or the amounts of the monomers used to make them. Such a description may not include a formal nomenclature used to describe the final polymer or may not contain product-by-process terminology. Nevertheless, any such reference to monomers and amounts means that the polymer is made from those monomers or that amount of the monomers, and also refers to the corresponding polymers and compositions thereof.

The materials, methods, and examples herein are illustrative only and, except as specifically stated, are not intended to be limiting.

Provided herein are safety laminates having improved sound damping and solar control properties. Specifically, described herein is an acoustic solar control laminate comprising or consisting essentially of a rigid sheet outer layer (e.g., a glass sheet layer), a monolayer acoustic interlayer sheet comprising an acoustic poly(vinyl acetal) composition, and a solar control polymeric film outer layer that is optionally hardcoated. The acoustic solar control laminate may optionally further comprise additional interlayer sheet(s) made of suitable polymeric materials other than the acoustic poly(vinyl acetals).

The acoustic solar control laminate described herein may further comprise adhesive layer(s) to enhance the bonding between the component layers. Conventional adhesives, such as silanes or poly(alkyl amines) may be used here. When one or more adhesive layer is present, they may be the same or different. Typically, however, the interlayer sheets described herein do not require an adhesive to promote adhesion to glass.

### Rigid Sheet Outer Layers

The rigid sheet outer layers used here may be selected from glass or rigid transparent polymeric sheets, such as sheets of polycarbonate, acrylics, polyacrylate, poly(methyl methacrylate), cyclic polyolefins (e.g., ethylene norbornene polymers), polystyrene (preferably metallocene-catalyzed) and the like and combinations thereof. Preferably, the rigid sheet comprises a material with a modulus of about 100,000 psi (690 MPa) or greater (as measured by ASTM Method D-638). Preferably, the rigid sheet is formed of glass, polycarbonate, poly(methyl methacrylate), or combinations thereof. More preferably, the rigid sheet is a glass sheet.

The term “glass” is meant to include not only window glass, plate glass, silicate glass, sheet glass, low iron glass, and float glass, but also includes colored glass, specialty glass which includes ingredients to control, for example, solar heating, coated glass with, for example, sputtered metals, such as silver or indium tin oxide, for solar control purposes, E-glass, Toroglass, Solex® glass (PPG Industries, Pittsburgh, Pa. (“PPG”)) and the like. Such specialty glasses are disclosed in, e.g., U.S. Pat. No. 4,615,989; U.S. Pat. No. 5,173,212; U.S. Pat. No. 5,264,286; U.S. Pat. No. 6,150,028; U.S. Pat. No. 6,340,646; U.S. Pat. No. 6,461,736; and U.S. Pat. No. 6,468,934. The glass may also include frosted or etched glass sheet. Frosted and etched glass sheets are articles of commerce and are well disclosed within the common art and literature. The type of glass to be selected for a particular laminate depends on the intended use.

### Acoustic Interlayer Sheets

Typically, the acoustic interlayer sheet used here is a monolayer sheet formed essentially of (or made essentially on an acoustic poly(vinyl acetal) composition. The term “acoustic poly(vinyl acetal) composition”, as used herein, refers to a poly(vinyl acetal) composition that has a glass transition temperature (Tg) of 23° C. or less. Preferably, the Tg is about 20° C. to about 23° C. The Tg of the poly(vinyl acetal) composition is determined as described in US 2006/0210776, by rheometric dynamic shear mode analysis, using the following procedure. A polymer sheet of an acoustic poly(vinyl acetal) composition is molded into a sample disc of 25 mm in diameter. The polymeric sample sheet is placed between two 25 mm diameter parallel plate test fixtures of a Rheometrics Dynamic Spectrometer II (available from Rheometrics, Incorporated, Piscataway, N.J.). The polymer sample sheet is tested in shear mode at an oscillation frequency of 1 Hertz as the temperature of the sample is increased from −20° C. to 70° C. at a rate of 2° C./minute. The position of the maximum value of tan delta (damping) plotted as dependent on temperature is used to determine glass transition temperature.

In one preferred embodiment, the acoustic poly(vinyl acetal) composition comprises at least one poly(vinyl acetal) with acetal groups derived from reacting poly(vinyl alcohol) with one or more aldehydes containing 6 to 10 carbon atoms. Preferably, the poly(vinyl acetal)s are produced by acetalizing poly(vinyl alcohol)s with one or more aldehydes containing 6 to 10 carbon atoms to a degree of acetalization of at least 50 mole %. Preferred poly(vinyl alcohol)s are those that have an average polymerization degree of from about 1000 to about 3000 and a saponification degree of at least 95 mole %. Preferably, the poly(vinyl alcohol) contains residual acetoxy groups in the range of from about 2 to about 0.01 mole % of the total of the main chain vinyl groups. The aldehydes having 6 to 10 carbon atoms may include aliphatic, aromatic or alicyclic aldehydes. The aliphatic aldehydes may include straight chain or branched alkyl groups. Specific examples of suitable aldehydes having 6 to 10 carbon atoms include n-hexylaldehyde, 2-ethylbutyraldehyde, n-heptylaldehyde, n-octylaldehyde, n-nonylaldehyde, n-decylaldehyde, benzaldehyde, and cinnamaldehyde. The aldehydes may be used alone or in combinations. Preferably, the aldehydes have 6 to 8 carbon atoms.

The poly(vinyl acetal)s in this embodiment may be produced through any known art method. For example, the poly(vinyl acetal)s may be prepared by dissolving the poly(vinyl alcohol) in hot water to obtain an aqueous solution, adding the desired aldehyde and catalyst to the solution which is maintained at the required temperature to cause the acetalization reaction to proceed. The reaction mixture is then maintained at an elevated temperature to complete the reaction, followed by neutralization, washing with water and drying to obtain the desired product in the form of a resin powder.

Suitable poly(vinyl acetal) compositions in this embodiment preferably further include one or more plasticizers. The plasticizer(s) to be admixed with the above produced poly(vinyl acetal)s may be a monobasic acid ester, a polybasic acid ester or like organic plasticizer, or an organic phosphate or organic phosphite plasticizer. Specific examples of preferred monobasic esters include glycol esters prepared by the reaction of triethylene glycol with butyric acid, isobutyric acid, caproic acid, 2-ethylbutyric acid, heptanoic acid, n-octylic acid, 2-ethylhexylic acid, pelagonic acid (n-nonylic acid), decylic acid, and the like and mixtures thereof. Additional useful monobasic acid esters may be prepared from tetraethylene glycol or tripropylene glycol with the above mentioned organic acids. Specific examples of preferred polybasic acid esters include those prepared from adipic acid, sebacic acid, azelaic acid, and the like and mixtures thereof, with a straight-chain or branched-chain alcohol having 4 to 8 carbon atoms. Specific examples of preferred phosphate or phosphite plasticizers include tributoxyethyl phosphate, isodecylphenyl phosphate, triisopropyl phosphite and the like and mixtures thereof. More preferable plasticizers include monobasic esters such as triethylene glycol di-2-ethylbutyrate, triethylene glycol di-2-ethylhexoate, triethylene glycol dicaproate and triethylene glycol di-n-octoate, and dibasic acid esters such as dibutyl sebacate, dioctyl azelate and dibutylcarbitol adipate.

Preferably the plasticizer is used in an amount of about 30 to about 60 parts by weight per 100 parts by weight of the poly(vinyl acetal). More preferably the plasticizer is used in an amount of about 30 to about 55 parts by weight per 100 parts by weight of the poly(vinyl acetal).

Further additives may also be incorporated into the acoustic poly(vinyl acetal) composition. For example, metal salts of carboxylic acids, including potassium, sodium, or the like alkali metal salts of octylic acid, hexylic acid, butyric acid, acetic acid, formic acid and the like, calcium, magnesium or the like alkaline earth metal salts of the above mentioned acids, zinc and cobalt salts of the above mentioned acids. Stabilizers, such as surfactants, including sodium laurylsulfate and alkylbenzenesulfonic acids, may also be included. Such acoustic poly(vinyl acetal) compositions are described within, for example, U.S. Pat. No. 5,190,826.

In a second preferred embodiment, the acoustic poly(vinyl acetal) composition comprises at least one poly(vinyl acetal) with acetoxy groups in the range of about 8 to about 30 mole % of the total of the main chain vinyl groups. Preferably the acoustic poly(vinyl acetal)s contain acetal groups derived from reacting poly(vinyl alcohol)s with one or more aldehydes containing 4 to 6 carbon atoms. The aldehydes are preferably aliphatic, and, when aliphatic, may include straight chain or branched alkyl groups. These acoustic poly(vinyl acetal)s may be prepared from poly(vinyl alcohol)s having an average degree of polymerization of about 500 to about 3000. More preferably, these poly(vinyl acetal)s may be prepared from poly(vinyl alcohol)s having an average degree of polymerization of about 1000 to about 2500. Specific examples of aldehydes which incorporate from 4 to 6 carbon atoms include, n-butyl aldehyde, isobutyl aldehyde, valeraldehyde, n-hexyl aldehyde and 2-ethylbutyl aldehyde and mixtures thereof. Preferable aldehydes which incorporate from 4 to 6 carbon atoms include n-butyl aldehyde, isobutyl aldehyde and n-hexyl aldehyde and mixtures thereof. More preferably, the aldehyde which incorporates from 4 to 6 carbon atoms is a n-butyl aldehyde and the poly(vinyl acetal) is poly(vinyl butyral). Preferably, the degree of acetalization for the resulting poly(vinyl acetal) is 40 mole % or greater, more preferably, 50 mole % or greater. These poly(vinyl acetal)s may be prepared as described above or below. Useful plasticizers as described above or below may also be included in these acoustic poly(vinyl acetal) compositions. Preferably the plasticizer is used in an amount of from about 30 to about 70 parts by weight per 100 parts by weight of the poly(vinyl acetal), more preferably about 35 to about 65 parts by weight per 100 parts by weight of the poly(vinyl acetal). Further additives may be incorporated into the acoustic poly(vinyl acetal) composition as described above or below. Such acoustic plasticized poly(vinyl acetal) compositions are described within, for example, U.S. Pat. No. 5,340,654 and EP 1 281 690.

In a third preferred embodiment, the acoustic poly(vinyl acetal) composition comprises at least one poly(vinyl acetal) and plasticizer(s) in an amount of about 40 to about 60 parts per hundred (pph) (preferably about 40 to about 50 pph) based on 100 parts by weight of the poly(vinyl acetal)s. Preferably the poly(vinyl acetal) is produced by acetalizing a poly(vinyl alcohol) with at least 95 mole % saponification degree. Preferably the acoustic poly(vinyl acetal) composition contains plasticizer in an amount of about 40 to about 60 parts per hundred (pph) based on 100 parts by weight of the poly(vinyl acetal). Preferably the poly(vinyl acetal) is a poly(vinyl butyral). Such acoustic poly(vinyl butyral) compositions are described, e.g., within US 2006/008648; US 2006/0210776 and US 2006/0210782.

The acoustic poly(vinyl butyral) of this embodiment will typically have a weight average molecular weight ranging from about 30,000 to about 600,000 Daltons (Da), or preferably, from about 45,000 to about 300,000 Da, or more preferably, from about 200,000 to about 300,000 Da, as measured by size exclusion chromatography using low angle laser light scattering. The preferable poly(vinyl butyral) material will incorporate 0 to about 10%, or preferably, 0 to about 3%, of residual ester groups, calculated as polyvinyl ester, typically acetate groups, with the balance being butyraldehyde acetal. The poly(vinyl butyral) may also incorporate a minor amount of acetal groups other than butyral, for example, 2-ethyl hexanal, as disclosed within U.S. Pat. No. 5,137,954.

Within this embodiment, usable plasticizers are those known within the art, for example, as disclosed within U.S. Pat. No. 3,841,890, U.S. Pat. No. 4,144,217, U.S. Pat. No. 4,276,351, U.S. Pat. No. 4,335,036, U.S. Pat. No. 4,902,464, U.S. Pat. No. 5,013,779, and WO 96/28504. Preferable plasticizers include diesters of polyethylene glycol such as triethylene glycol di(2-ethylhexanoate), tetraethylene glycol diheptanoate and triethylene glycol di(2-ethylbutyrate) and dihexyl adipate. Preferably, the plasticizer is one that is compatible, that is, one that forms a single phase when mixed with a poly(vinyl butyral) resin having a hydroxyl number (OH number) of about 12 to about 23 in the amounts described hereinabove.

In the above acoustic poly(vinyl acetal) compositions, an adhesion control additive, for controlling the adhesive bond between the rigid sheet layers and the acoustic poly(vinyl acetal) sheets, may also be included. These are generally alkali metal or alkaline earth metal salts of organic and inorganic acids. Preferably, they are alkali metal or alkaline earth metal salts of organic carboxylic acids having from 2 to 16 carbon atoms. More preferably, they are magnesium or potassium salts of organic carboxylic acids having from 2 to 16 carbon atoms. The adhesion control additive is typically used in the range of about 0.001 to about 0.5 wt % based on the total weight of the polymeric sheet composition.

It is understood that the acoustic poly(vinyl acetal) compositions may further comprise one or more suitable additives. The additives may include fillers, plasticizers, processing aides, flow enhancing additives, lubricants, pigments, dyes, colorants, flame retardants, impact modifiers, nucleating agents, lubricants, antiblocking agents such as silica, slip agents, antioxidants, thermal stabilizers, UV absorbers, UV stabilizers, hindered amine light stablizers, dispersants, surfactants, chelating agents, coupling agents, adhesives, primers, additives described in U.S. Pat. No. 5,190,826, and the like. Further details regarding some preferred additives are set forth below.

The acoustic poly(vinyl acetal) compositions may contain an effective amount of a thermal stabilizer. Thermal stabilizers are well disclosed within the art. Preferable general classes of thermal stabilizers include phenolic antioxidants, alkylated monophenols, alkylthiomethylphenols, hydroquinones, alkylated hydroquinones, tocopherols, hydroxylated thiodiphenyl ethers, alkylidenebisphenols, O—, N- and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds which destroy peroxide, hydroxylamines, nitrones, thiosynergists, benzofuranones, indolinones, and the like and mixtures thereof. This should not be considered limiting. Essentially any thermal stabilizer can be used. The compositions preferably incorporate 0 to about 1.0 wt % of thermal stabilizers, based on the total weight of the composition.

The acoustic poly(vinyl acetal) compositions may contain an effective amount of UV absorber(s). UV absorbers are well disclosed within the art. Preferable general classes of UV absorbers include benzotriazoles, hydroxybenzophenones, hydroxyphenyl triazines, esters of substituted and unsubstituted benzoic acids, and the like and mixtures thereof. This should not be considered limiting. Essentially any UV absorber may be used. The compositions preferably contain 0 to about 1.0 wt % of UV absorbers, based on the total weight of the composition.

The acoustic poly(vinyl acetal) compositions may contain an effective amount of hindered amine light stabilizers (HALS). Hindered amine light stabilizers are generally well disclosed within the art. Generally, hindered amine light stabilizers are disclosed to be secondary, tertiary, acetylated, N-hydrocarbyloxy substituted, hydroxy substituted N-hydrocarbyloxy substituted, or other substituted cyclic amines which further contain steric hindrance, generally derived from aliphatic substitution on the carbon atoms adjacent to the amine function. This should not be considered limiting. Essentially any hindered amine light stabilizer may be used. The compositions preferably contain 0 to about 1.0 wt % of hindered amine light stabilizers, based on the total weight of the composition.

The acoustic interlayer sheet used here is preferably a monolayer sheet. Typically, the acoustic interlayer sheet has a thickness of at least about 10 mils (0.25 mm), or at least about 15 mils (0.38 mm), or at least about 30 mils (0.76 mm). To provide the properties required for the expected performance of conventional poly(vinyl acetal) sheeting, the thickness of the acoustic interlayer sheet used here should be in the range of about 15-70 mils (0.38-1.78 mm), or about 20-60 mils (0.5-1.5 mm), or about 30-45 mils (0.76-1.1 mm) at the thickest point. In a preferred embodiment, the sheet thickness is homogeneous across the width of the sheet, e.g., the thickness is the same at all edges of the sheet. The interlayer sheets used herein may be of any width and length.

The acoustic interlayer sheets used here may be formed by any suitable process, such as extrusion, calendering, solution casting or injection molding. The parameters for each of these processes can be easily determined by one of ordinary skill in the art depending upon viscosity characteristics of the polymeric composition used and the desired thickness of the sheet.

The acoustic interlayer sheets are preferably formed by extrusion.

The acoustic interlayer sheets may have a smooth surface. Preferably, the acoustic interlayer sheets have a roughened surface to effectively allow most of the air to be removed from between the surfaces of the laminate layers during the lamination process. This can be accomplished, for example, by mechanically embossing the sheets after extrusion or by extruding the sheets under melt fracture conditions and the like.

The acoustic interlayer sheets may be further modified to provide valuable attributes to the sheets and to the laminates produced therefrom. For example, the sheets may be treated by radiation, for example E-beam treatment of the sheets. E-beam treatment of the acoustic poly(vinyl acetal) sheets with an intensity in the range of about 2 to about 20 MRd will provide an increase of about 20° C. to about 50° C. in the softening point (i.e., Vicat Softening Point) of the sheets. Preferably, the radiation intensity is from about 2.5 to about 15 MRd.

### Other Optional Interlayer Sheets

The other optional interlayer sheets used here may be prepared from or made of any suitable polymeric materials. Preferably, however, the other optional interlayer sheets are made of polymeric materials having modulus of about 20,000 psi (138 MPa) or less, or about 15,000 psi (104 MPa) or less. Most preferably, the other optional interlayer sheets are made of polymeric materials selected from poly(ethylene-co-vinyl acetates), poly(vinyl butyrals), and combinations thereof.

### Solar Control Films

The polymeric film outer layer may be formed of any suitable polymeric material. Preferably, however, the polymeric film layer is a polyester film, more preferably a film comprising poly(ethylene terephthalate), or still more preferably, a bi-axially oriented poly(ethylene terephthalate) (PET) film.

The polymeric film has an inbound surface that is proximal to or adjacent to the polymeric interlayer and an outbound surface that is distal to the polymeric interlayer sheet. In addition, at least one of the two surfaces of the polymeric film is at least partially coated with an infrared energy reflective layer. Such an infrared energy reflective layer may be a simple semi-transparent metal layer or a series of metal/dielectric layers.

The stacks of metal/dielectric layers are commonly referred to as interference filters of the Fabry-Perot type. Each layer may be on the order of an angstrom (Å) thick or thicker. The thickness of the various layers in the filter is controlled to achieve an optimum balance between the desirable infrared reflectance while maintaining the accepted visible light transmittance. The metal layers are separated (i.e. vertically in the thickness direction) from each other by one or more dielectric layers so the reflection of visible light from the metal layers interferes destructively and thereby enhances the visible light transmission. Suitable metals for the metal layers include, e.g., silver, palladium, aluminum, chromium, nickel, copper, gold, zinc, tin, brass, stainless steel, titanium nitride, and alloys or claddings thereof. For optical purposes, silver and silver-gold alloys are preferred. Metal layer thickness generally ranges from about 60 to about 200 Å, or preferably, from about 80 to about 140 Å.

In general, the dielectric material should be chosen so that its refractive index is greater than the material outside the coating it abuts. It is desired that dielectric materials with a relatively high refractive index be used here. Preferably, the dielectric material may have a refractive index greater than about 1.8, or more preferably, greater than about 2.0. Additionally, the dielectric material should be transparent over the visible range. Suitable dielectric materials for the dielectric layers include, but are not limited to, zirconium oxide, tantalum oxide, tungsten oxide, indium oxide, tin oxide, indium tin oxide, aluminum oxide, zinc sulfide, zinc oxide, magnesium fluoride, niobium oxide, silicon nitride, and titanium oxide. Preferably the dielectric materials are selected from tungsten oxides, indium oxides, tin oxides, and indium tin oxides.

Generally, the metal/dielectric layers are applied onto the polymeric films through vacuum deposition processes, such as vacuum evaporation processes or sputtering deposition processes. Examples of such processes include resistance heated, laser heated or electron-beam vaporization evaporation processes and DC or RF sputtering processes (diode and magnetron) under normal and reactive conditions.

In one preferred embodiment, the solar control polymeric film is in the form of an interference filter film, such as those disclosed in U.S. Pat. No. 4,799,745 and U.S. Pat. No. 4,973,511. In particular, U.S. Pat. No. 4,799,745 discloses a transparent, infrared reflecting composite film including a transparent polymeric film layer (e.g., a poly(ethylene terephthalate) film) and adhered to one side of the film layer a filter coating, which is formed of at least two transparent metal layers separated from one another by a dielectric layer; and U.S. Pat. No. 4,973,511 discloses a solar control film comprising a transparent polymeric film layer (e.g., a poly(ethylene terephthalate) film) and coated to one side of the film layer a filter coating, which is formed of (i) at least one metal layer and at least one adjacent adherent dielectric layer or (ii) at least one metal layer and bonded on each side thereof at least two dielectric layers.

In such films, the coating layers may be further adjusted to reflect particular wave lengths of energy, in particular, heat and other infrared wavelengths. For example, as it is generally known within the art, varying the thickness and composition of a dielectric layer spaced between two reflecting metal layers will vary the optical transmittance/reflection properties considerably. More specifically, varying the thickness of the spacing between the dielectric layers varies the wave length associated with the reflection suppression (or transmission enhancement) band. In addition to the choice of metal, thickness also determines its reflectivity. Generally, the thinner the layer, the less its reflectivity is. To obtain desirable optical properties, the thickness of the spacing between the dielectric layer(s) is preferably about 200 to about 1200 Å, or more preferably, about 450 to about 1000 Å.

For automotive end-uses, the metal/dielectric stacks preferably contain at least two near infrared reflecting metal layers which in operative position transmit at least 70% visible light of normal incidence measured as specified in ANSI Z26.1. For architectural applications, the metal/dielectric stacks may have lower levels of visible light transmittance. Preferably, however, the visible light reflectance from the surface of the metal/dielectric stack should be less than about 8%. The inclusion of exterior dielectric layers in contact with the metal layer surfaces opposite to the metal surfaces contacting spacing dielectric layer(s) may further enhance anti-reflection performance. The thickness of such exterior or outside dielectric layer(s) is generally about 20 to about 600 Å, or preferably, about 50 to about 500 Å.

The above description should not be considered limiting. Essentially any polymeric film with a coating of an infrared reflecting material may find utility in the acoustic solar control laminates described herein.

Commercial examples of solar control polymeric films coated with metal/dielectric stacks are available from Southwall Technologies, Inc. (Palo Alto, Calif. (“Southwall”)) under the trade names of XIR™ 70 and XIR™ 75.

Preferably, the polymeric film used here is further coated, at least partially, with an abrasion-resistant hardcoat on its outside surface. In a preferred laminate, the polymeric film has its inside surface coated with the infrared energy reflective layer and its outside surface coated with the abrasion-resistant hardcoat. Stated alternatively, in the preferred laminate, the side of the polymeric film bearing the solar control coating is proximal to or adjacent to the polymeric interlayer, and the side of the polymeric film bearing the hardcoat is opposite from or distal to the polymeric interlayer.

Suitable abrasion-resistant hardcoats may be formed of polysiloxanes or cross-linked (thermosetting) polyurethanes, such as those disclosed in U.S. Pat. No. 5,567,529 and U.S. Pat. No. 5,763,089. Also suitable for use herein are the oligomeric-based coatings disclosed in US 2005/0077002, which compositions are prepared by the reaction of (A) hydroxyl-containing oligomer with isocyanate-containing oligomer or (B) anhydride-containing oligomer with epoxide-containing compound.

In practice, prior to applying the hardcoat, the outside surface of the polymeric film may need to undergo certain energy treatments or be coated with certain primers to enhance the bonding between the polymeric films and the hardcoats. The certain energy treatments may be a controlled flame treatment, a corona treatment or a plasma treatment. For example, flame treating techniques have been disclosed in U.S. Pat. No. 2,632,921; U.S. Pat. No. 2,648,097; U.S. Pat. No. 2,683,984; and U.S. Pat. No. 2,704,382, and plasma treating techniques have been disclosed in U.S. Pat. No. 4,732,814. The primers that are useful include poly(alkyl amines) (e.g., poly(allyl amines)) and acrylic based primers (e.g., acrylic hydrosol as disclosed in U.S. Pat. No. 5,415,942).

### Lamination Process

The safety glass laminates disclosed herein may be produced through autoclave and non-autoclave processes, as described below.

In a conventional autoclave process, the glass outer layer, the interlayer sheet(s), and the optionally hardcoated solar control film outer layer are laminated together under heat and pressure. Preferably, the glass outer layer is a 90 mil thick annealed flat glass which has been washed and dried.

Before lamination, the individual layers are stacked in the desired order to form the pre-press assembly. A typical pre-press assembly may include, in order, a glass outer layer, a polymeric interlayer, and an optionally hard-coated polymeric film outer layer, a release liner, and a rigid cover plate. The cover plate used here is preferably formed of glass or other suitable rigid materials and is similar in shape to the glass outer layer. The release liner may be formed of Teflon®, e.g., in which case it does not adhere to the polymeric film outer layer. Alternatively, the release liner may be at least partially coated with an adhesive, such as a pressure-sensitive adhesive, so that it may stay in place and protect the polymeric film outer layer from insults that may be sustained when the laminate is shipped or installed. The structure as assembled above then undergoes a lamination process with or without an autoclaving step.

For example, the assembly is placed into a bag capable of sustaining a vacuum (“a vacuum bag”), the air is drawn out of the bag by a vacuum line or other means, the bag is sealed while the vacuum is maintained (for example, in the range of about 27-28 inches Hg (689-711 mm Hg)), and the sealed bag is placed in an autoclave at a temperature of about 130° C. to about 180° C., at a pressure of about 150 to about 250 psi (about 11.3 to about 18.8 bar), for about 10 to about 50 minutes. Preferably the bag is autoclaved at a temperature of about 120° C. to about 160° C. for 20 to about 45 minutes. More preferably the bag is autoclaved at a temperature of about 135° C. to about 160° C. for about 20 to about 40 minutes. Most preferably the bag is autoclaved at a temperature of about 145° C. to about 155° C. for about 25 to about 35 minutes. A vacuum ring may be substituted for the vacuum bag. One type of suitable vacuum bag is disclosed within U.S. Pat. No. 3,311,517.

Alternatively, other processes may be used to produce the laminates. Any air trapped within the glass/multi-layer interlayer/glass assembly may be removed through a nip roll process. For example, the assembly may be heated in an oven at about 80° C. to about 120° C., preferably about 90° C. to about 100° C., for about 20 to about 40 minutes. Thereafter, the heated assembly is passed through a set of nip rolls so that the air in the void spaces between the glass and the interlayer may be squeezed out, and the edge of the assembly sealed. The assembly at this stage is referred to as a “pre-press assembly”.

The pre-press assembly may then be placed in an air autoclave where the temperature is raised to about 120° C.-160° C., or about 135° C.-160° C., at a pressure of about 100-300 psi (6.9-20.7 bar), or about 200 psi (13.8 bar). These conditions are maintained for about 15-60 min, or about 20-50 min, after which, the air is cooled while no more air is added to the autoclave. After about 20-40 min of cooling, the excess air pressure is vented and the laminates are removed from the autoclave. This should not be considered limiting. Essentially any lamination process may be used.

The laminates can also be produced through non-autoclave processes. Such non-autoclave processes are disclosed, for example, within U.S. Pat. No. 3,234,062; U.S. Pat. No. 3,852,136; U.S. Pat. No. 4,341,576; U.S. Pat. No. 4,385,951; U.S. Pat. No. 4,398,979; U.S. Pat. No. 5,536,347; U.S. Pat. No. 5,853,516; U.S. Pat. No. 6,342,116; U.S. Pat. No. 5,415,909; US 2004/0182493; EP 1 235 683 B1; WO 91/01880; and WO 03/057478 A1. Generally, the non-autoclave processes include heating the pre-press assembly and the application of vacuum, pressure or both. For example, the pre-press may be successively passed through heating ovens and nip rolls.

### EXAMPLES

The following examples are provided to describe the invention in further detail. These examples, which set forth a preferred mode presently contemplated for carrying out the invention, are intended to illustrate and not to limit the invention.

### Determination of Solar Control Properties

In the following examples, the solar control properties were measured according to the procedures set forth in ASTM test method E424, ASTM test method E308, and in the ISO9050:2003 and ISO 13837 test methods using a Perkin Elmer Lambda 19 spectrophotometer.

### Example 1

A glass laminate (2×2 in (51×51 mm)) was produced in the following manner. First, a pre-press assembly was laid up. The pre-press assembly included, in order, a Solex® green glass layer (3 mm), a Butacite® poly(vinyl butyral) sheet (DuPont) (15 mils (0.38 mm)), an acoustic poly(vinyl butyral) sheet (30 mils (0.76 mm)), a second Butacite® poly(vinyl butyral) sheet (15 mils (0.38 mm)), and a XIR® 70 HP Auto film (Southwall) (2 mils (0.05 mm)), in which (a) the acoustic poly(vinyl butyral) sheet comprised 100 pph of poly(vinyl butyral) with a hydroxyl number of 18.5 and 48.5 pph of plasticizer tetraethylene glycol diheptanoate and (b) the metallized surface of the XIR® 70 HP Auto film was in contact with the second Butacite® poly(vinyl butyral) sheet. The Butacite® sheets, the XIR® 70 HP Auto film, and the acoustic poly(vinyl butyral) layer, were conditioned at 23% relative humidity (RH) at a temperature of 72° F. overnight. The laminate layers were laid up with the XIR® 70 HP Auto film further covered with a thin Teflon® film layer (DuPont), which was in turn covered by a cover sheet of annealed float glass (90 mils (2.3 mm)). The assembly was then placed into a vacuum bag and heated to 90-100° C. for 30 min to remove any air contained between the laminate layers. The assembly was then subjected to autoclaving at 135° C. for 30 min in an air autoclave to a pressure of 200 psig (13.8 bar). The air was then cooled while no more air was added to the autoclave. After 20 min of cooling when the air temperature was less than about 50° C., the excess pressure was vented, the assembly was removed from the autoclave, the desired laminate was then obtained by removing the Teflon® film and the glass cover sheet.

The laminate was tested for solar control properties as described above and found to have a solar transmission of 0.319, and a visible transmission of 0.660.

### Example 2

By the same process used in Example 1, there was produced a glass laminate (2×2 in (51×51 mm)) composed of a clear annealed glass layer (90 mils (2.3 mm)), an acoustic poly(vinyl butyral) sheet layer (30 mils (0.76 mm)), an Evasafe® poly(ethylene-co-vinyl acetate) sheet (Bridgestone Corporation, Nashville, Tenn. (“Bridgestone”)) (17 mils (0.43 mm)), and a XIR® 70 HP Auto film (2 mils (0.05 mm)), in which (a) the acoustic poly(vinyl butyral) sheet comprised 100 pph of poly(vinyl butyral) with a hydroxyl number of 18.5 and 48.5 pph of plasticizer tetraethylene glycol diheptanoate and (b) the metallized surface of the XIR® 70 HP Auto film was in contact with the Evasafe® poly(ethylene-co-vinyl acetate) sheet.

The laminate was tested for solar control properties as described above and found to have a solar transmission of 0.330, and a visible transmission of 0.639.

### Example 3

By the same process used in Example 1, there was produced a glass laminate (2×2 in (51×51 mm)) composed of a Solex® green glass layer (3 mm), a Butacite® poly(vinyl butyral) sheet (15 mils (0.38 mm)), an acoustic poly(vinyl butyral) sheet layer (30 mils (0.76 mm)), a second Butacite® poly(vinyl butyral) sheet (15 mils (0.38 mm)), and a XIR® 70 Auto Blue V.1 film layer (Southwall) (1.8 mils (0.05 mm)), in which (a) the acoustic poly(vinyl butyral) sheet comprised 100 pph of poly(vinyl butyral) with a hydroxyl number of 18.5 and 48.5 pph of plasticizer tetraethylene glycol diheptanoate and (b) the metallized surface of the XIR® 70 Auto Blue V.1 film was in contact with the second Butacite® poly(vinyl butyral) sheet.

The laminate was tested for solar control properties as described above and found to have a solar transmission of 0.418, and a visible transmission of 0.707.

### Example 4

By the same process used in Example 1, there was produced a glass laminate (2×2 in (51×51 mm)) composed of a clear annealed glass layer (90 mils (2.3 mm)), an acoustic poly(vinyl butyral) sheet (30 mils (0.38 mm)), an Evasafe® poly(ethylene-co-vinyl acetate) sheet (17 mils (0.4 mm)), and a XIR® 70 Auto Blue V.1 film (1.8 mils (0.05 mm)), in which (a) the acoustic poly(vinyl butyral) sheet comprised 100 pph of poly(vinyl butyral) with a hydroxyl number of 18.5 and 48.5 pph of plasticizer tetraethylene glycol diheptanoate and (b) the metallized surface of the XIR® 70 Auto Blue V.1 film was in contact with the Evasafe® poly(ethylene-co-vinyl acetate) sheet.

The laminate was tested for solar control properties as described above and found to have a solar transmission of 0.449, and a visible transmission of 0.668.

### Example 5

By the same process used in Example 1, there was produced a glass laminate (2×2 in (51×51 mm)) composed of a Solex® green glass layer (3 mm), a Butacite® poly(vinyl butyral) sheet (15 mils (0.38 mm)), an acoustic poly(vinyl butyral) sheet layer (30 mils (0.76 mm)), a second Butacite® poly(vinyl butyral) sheet (15 mils (0.38 mm)), and a XIR® 75 Green film (Southwall) (1.8 mils (0.05 mm)), in which (a) the acoustic poly(vinyl butyral) sheet comprised 100 parts pph of poly(vinyl butyral) with a hydroxyl number of 18.5 and 48.5 pph of plasticizer tetraethylene glycol diheptanoate and (b) the metallized surface of the XIR® 75 Green film was in contact with the second Butacite® poly(vinyl butyral) sheet.

The laminate was tested for solar control properties as described above and found to have a solar transmission of 0.423, and a visible transmission of 0.706.

### Example 6

By the same process used in Example 1, there was produced a glass laminate (2×2 in (51×51 mm)) composed of a clear annealed glass layer (90 mils (2.3 mm)), an acoustic poly(vinyl butyral) sheet layer (30 mils (0.76 mm)), an Evasafe® poly(ethylene-co-vinyl acetate) sheet (17 mils (0.4 mm)), and a XIR® 75 Green film (1.8 mils (0.05 mm)), in which (a) the acoustic poly(vinyl butyral) sheet comprised 100 pph of poly(vinyl butyral) with a hydroxyl number of 18.5 and 48.5 pph of plasticizer tetraethylene glycol diheptanoate and (b) the metallized surface of the XIR® 75 Green film was in contact with the Evasafe® poly(ethylene-co-vinyl acetate) sheet.

The laminate was tested for solar control properties as described above and found to have a solar transmission of 0.452, and a visible transmission of 0.664.

### Example 7

By the same process used in Example 1, there was produced a glass laminate (2×2 in (51×51 mm)) composed of a Solex® green glass layer (3 mm), a Butacite® poly(vinyl butyral) sheet (15 mils (0.38 mm)), an acoustic poly(vinyl butyral) sheet (30 mils (0.76 mm)), a second Butacite® poly(vinyl butyral) sheet (15 mils (0.38 mm)), and a XIR® Laminated 72-47 film layer (Southwall) (2 mils (0.05 mm)), in which (a) the acoustic poly(vinyl butyral) sheet comprised 100 pph of poly(vinyl butyral) with a hydroxyl number of 18.5 and 48.5 pph of plasticizer tetraethylene glycol diheptanoate and (b) the metallized surface of the XIR® Laminated 72-47 film was in contact with the second Butacite® poly(vinyl butyral) sheet.

The laminate was tested for solar control properties as described above and found to have a solar transmission of 0.378, and a visible transmission of 0.678.

### Example 8

By the same process used in Example 1, there was produced a glass laminate (2×2 in (51×51 mm)) composed of a clear annealed glass layer (90 mils (2.3 mm)), an acoustic poly(vinyl butyral) sheet layer (30 mils (0.76 mm)), an Evasafe® poly(ethylene-co-vinyl acetate) sheet (17 mils (0.4 mm)), and a XIR® Laminated 72-47 film (2 mils (0.05 mm)), in which (a) the acoustic poly(vinyl butyral) sheet comprised 100 pph of poly(vinyl butyral) with a hydroxyl number of 18.5 and 48.5 pph of plasticizer tetraethylene glycol diheptanoate and (b) the metallized surface of the XIR® Laminated 72-47 film was in contact with the Evasafe® poly(ethylene-co-vinyl acetate) sheet.

The laminate was tested for solar control properties as described above and found to have a solar transmission of 0.393, and a visible transmission of 0.634.

### Example 9

By the same process used in Example 1, there was produced a glass laminate (2×2 in (51×51 mm)) composed of a Solex® green glass layer (3 mm), a Butacite® poly(vinyl butyral) sheet (15 mils (0.38 mm)), an acoustic poly(vinyl butyral) sheet layer (30 mils (0.76 mm)), a second Butacite® poly(vinyl butyral) sheet (15 mils (0.38 mm)), and a XIR® 70 HP film (Southwall) (1 mil (0.03 mm)), in which (a) the acoustic poly(vinyl butyral) sheet comprised 100 pph of poly(vinyl butyral) with a hydroxyl number of 18.5 and 48.5 pph of plasticizer tetraethylene glycol diheptanoate and (b) the metallized surface of the XIR® 70 HP film was in contact with the second Butacite® poly(vinyl butyral) sheet.

The laminate was tested for solar control properties as described above and found to have a solar transmission of 0.323, and a visible transmission of 0.668.

### Example 10

By the same process used in Example 1, there was produced a glass laminate (2×2 in (51×51 mm)) composed of a clear annealed glass layer (90 mils (2.3 mm)), an acoustic poly(vinyl butyral) sheet layer (30 mils (0.76 mm)), an Evasafe® poly(ethylene-co-vinyl acetate) sheet (17 mils (0.4 mm)), and a XIR® 70 HP film (1 mil (0.03 mm)), in which (a) the acoustic poly(vinyl butyral) sheet comprised 100 pph of poly(vinyl butyral) with a hydroxyl number of 18.5 and 48.5 pph of plasticizer tetraethylene glycol diheptanoate and (b) the metallized surface of the XIR® 70 HP film was in contact with the Evasafe® poly(ethylene-co-vinyl acetate) sheet.

The laminate was tested for solar control properties as described above and found to have a solar transmission of 0.327, and a visible transmission of 0.637.

### Example 11

By the same process used in Example 1, there is produced a glass laminate (2×2 in (51×51 mm)) composed of a clear annealed glass layer (90 mils (2.3 mm)), an acoustic poly(vinyl butyral) sheet layer (30 mils (0.76 mm)), and a biaxially-oriented poly(ethylene terephthalate) film layer (4 mils (0.1 mm)), in which the acoustic poly(vinyl butyral) sheet comprises 100 pph of poly(vinyl butyral) with a hydroxyl number of 18.5 and 48.5 pph of plasticizer tetraethylene glycol diheptanoate.

### Example 12

By the same process used in Example 1, there is produced a glass laminate (2×2 in (51×51 mm)) composed of a clear annealed glass layer (90 mils (2.3 mm)), an acoustic poly(vinyl butyral) sheet layer (30 mils (0.76 mm)), and a surface flame-treated, biaxially-oriented poly(ethylene terephthalate) film layer (4 mils), in which the acoustic poly(vinyl butyral) sheet comprises 100 pph of poly(vinyl butyral) with a hydroxyl number of 18.5 and 48.5 pph of plasticizer tetraethylene glycol diheptanoate.

### Example 13

By the same process used in Example 1, there is produced a glass laminate (2×2 in (51×51 mm)) composed of a clear annealed glass layer (90 mils (2.3 mm)), an acoustic poly(vinyl butyral) sheet layer (30 mils (0.76 mm)), and a poly(allyl amine)-primed, biaxially-oriented poly(ethylene terephthalate) film layer (4 mils (0.1 mm)), in which the acoustic poly(vinyl butyral) sheet comprises 100 pph of poly(vinyl butyral) with a hydroxyl number of 18.5 and 48.5 pph of plasticizer tetraethylene glycol diheptanoate.

### Example 14

By the same process used in Example 1, there is produced a glass laminate (2×2 in (51×51 mm)) composed of a clear annealed glass layer (90 mils (2.3 mm)), an acoustic poly(vinyl butyral) sheet layer (30 mils (0.76 mm)), and a RAYBARRIER® TFK-2583 film layer (Sumitomo Osaka Cement Co., Ltd., Japan (“Sumitomo Osaka Cement”)), in which (a) the acoustic poly(vinyl butyral) sheet comprises 100 pph of poly(vinyl butyral) with a hydroxyl number of 18.5 and 48.5 pph of plasticizer tetraethylene glycol diheptanoate and (b) the coated surface of the RAYBARRIER® TFK-2583 film layer in contact with the acoustic poly(vinyl butyral) sheet layer.

### Example 15

By the same process used in Example 1, there is produced a glass laminate (2×2 in (51×51 mm)) composed of a clear annealed glass layer (90 mils (2.3 mm)), an acoustic poly(vinyl butyral) sheet layer (30 mils (0.76 mm)), and a Soft Look® UV/IR 25 solar control film layer (Tomoegawa Paper Co., Ltd., Japan (“Tomoegawa Paper”)), in which (a) the acoustic poly(vinyl butyral) sheet comprises 100 pph of poly(vinyl butyral) with a hydroxyl number of 18.5 and 48.5 pph of plasticizer tetraethylene glycol diheptanoate and (b) the coated surface of the Soft Look® UV/IR 25 solar control film layer is in contact with the acoustic poly(vinyl butyral) sheet layer.

### Example 16

By the same process used in Example 1, there is produced a glass laminate (2×2 in (51×51 mm)) composed of a clear annealed glass layer (90 mils (2.3 mm)), an acoustic poly(vinyl butyral) sheet (30 mils (0.76 mm)), and a XIR® 70 HP film layer (1 mil (0.03 mm)), in which (a) the acoustic poly(vinyl butyral) sheet comprises 100 pph of poly(vinyl butyral) with a hydroxyl number of 18.5 and 48.5 pph of plasticizer tetraethylene glycol diheptanoate and (b) the metallized surface of the XIR® 70 HP film layer is in contact with the acoustic poly(vinyl butyral) sheet.

### Example 17

By the same process used in Example 1, there is produced a glass laminate (2×2 in (51×51 mm)) composed of a clear annealed glass layer (90 mils (2.3 mm)), an acoustic poly(vinyl butyral) sheet layer (30 mils (0.76 mm)), and a XIR® 70 HP Auto film layer (2 mils (0.05 mm)), in which (a) the acoustic poly(vinyl butyral) sheet comprises 100 pph of poly(vinyl butyral) with a hydroxyl number of 18.5 and 48.5 pph of plasticizer tetraethylene glycol diheptanoate and (b) the metallized surface of the XIR® 70 HP Auto film layer is in contact with the acoustic poly(vinyl butyral) sheet layer.

### Example 18

By the same process used in Example 1, there is produced a glass laminate (2×2 in (51×51 mm)) composed of a clear annealed glass layer (90 mils (2.3 mm)), an acoustic poly(vinyl butyral) sheet layer (30 mils (0.76 mm)), and a XIR® 70 Auto Blue V.1 film layer (1.8 mils (0.05 mm)), in which (a) the acoustic poly(vinyl butyral) sheet comprises 100 pph of poly(vinyl butyral) with a hydroxyl number of 18.5 and 48.5 pph of plasticizer tetraethylene glycol diheptanoate and (b) the metallized surface of the XIR® 70 Auto Blue V.1 film layer is in contact with the acoustic poly(vinyl butyral) sheet layer.

While a number of the preferred embodiments of the present invention have been described and specifically exemplified above, it is not intended that the invention be limited to such embodiments. Various modifications may be made without departing from the scope and spirit of the present invention, as set forth in the following claims.

1. An acoustic solar control laminate consisting essentially of an acoustic polymeric interlayer sheet bonded between a rigid sheet and a polymeric film, wherein:
(a) the rigid sheet is formed of a material having a modulus of at least about 100,000 psi (690 MPa);
(b) the acoustic polymeric interlayer sheet consists of a monolayer sheet comprising an acoustic poly(vinyl acetal) composition having a glass transition temperature of 23° C. or less;
(c) the polymeric film has an inbound surface that is adjacent to the polymeric interlayer and an outbound surface that is distal to the polymeric interlayer sheet; and
(d) at least one of the two surfaces of the polymeric film is at least partially coated with an infrared energy reflective layer comprising a metal layer or a Fabry-Perot type interference filter layer.

2. (canceled)

3. (canceled)

4. The acoustic solar control laminate of claim 1, wherein the outbound surface of the polymeric film is further at least partially coated with an abrasion-resistant hardcoat.

5. The acoustic solar control laminate of claim 1, wherein the acoustic poly(vinyl acetal) composition comprises a poly(vinyl acetal) produced by acetalizing a poly(vinyl alcohol) with one or more aldehydes containing 6 to 10 carbon atoms.

6. The acoustic solar control laminate of claim 5, wherein the poly(vinyl acetal) has an acetalization degree of at least about 50 mole %.

7. The acoustic solar control laminate of claim 5, wherein the acoustic poly(vinyl acetal) composition further comprises a plasticizer.

8. The acoustic solar control laminate of claim 1, wherein the acoustic poly(vinyl acetal) composition comprises a poly(vinyl acetal) having about 8 to about 30 mole % of acetoxy groups, based on the total number of moles of vinyl groups in the poly(vinyl acetal).

9. The acoustic solar control laminate of claim 8, wherein the poly(vinyl acetal) is produced by acetalizing a poly(vinyl alcohol) with an aldehyde containing 4 to 6 carbon atoms.

10. The acoustic solar control laminate of claim 9, wherein the aldehyde is n-butyl aldehyde and the poly(vinyl acetal) is a poly(vinyl butyral).

11. The acoustic solar control laminate of 8, wherein the acoustic poly(vinyl acetal) composition further comprises a plasticizer.

12. The acoustic solar control laminate of claim 1, wherein the acoustic poly(vinyl acetal) composition comprises a poly(vinyl acetal) and about 40 to about 60 parts per hundred (pph) of a plasticizer, based on 100 parts by weight of the poly(vinyl acetal).

13. The acoustic solar control laminate of claim 12, wherein the poly(vinyl acetal) is a poly(vinyl butyral).

14. The acoustic solar control laminate of claim 1, wherein the acoustic poly(vinyl acetal) sheet has a thickness of at least about 10 mils (0.25 mm).

15. The acoustic solar control laminate of claim 12, wherein the acoustic poly(vinyl acetal) sheet has a thickness of about 15 to 70 mils (0.38 to 1.74 mm).

16. The acoustic solar control laminate of claim 1, wherein the rigid sheet is a glass sheet.

17. The acoustic solar control laminate of claim 1, wherein the polymeric film comprises a polyester.

18. The acoustic solar control laminate of claim 17, wherein the polymeric film comprises a poly(ethylene terephthalate).

19. The acoustic solar control laminate of claim 4, wherein the abrasion-resistant hardcoat is formed of a material selected from the group consisting of polysiloxanes, cross-linked polyurethanes, and composition prepared by the reaction of (A) hydroxyl-containing oligomer with isocyanate-containing oligomer or (B) anhydride-containing oligomer with epoxide-containing compound.

20. The acoustic solar control laminate of claim 4, wherein the polymeric film has the infrared energy reflective layer coated on both surfaces and the abrasion-resistant hardcoat coated to the outbound surface over the infrared energy reflective layer.

21. The acoustic solar control laminate of claim 4, wherein the polymeric film has the infrared energy reflective layer coated on the inbound surface and the abrasion-resistant hardcoat coated on the outbound surface.

22. (canceled)

23. The acoustic solar control laminate of claim 1, wherein (a) the rigid sheet is a glass sheet and (b) the polymeric film comprises a poly(ethylene terephthalate) and has an inbound surface, which is adjacent to the polymeric interlayer sheet, coated with an infrared energy reflective layer comprising a metal layer or a Fabry-Perot type interference filter layer and an outbound surface, which is further away from the polymeric interlayer sheet, coated with an abrasion-resistant hardcoat.
